(19) United States
(12) Patent Application Publication
(10) Pub. No.: US 2004/0240653 A1
(43) Pub. Date: Dec. 2, 2004

(54) Information communication apparatus and method

(76) Inventor: Artoun Ramian, Marbella (ES)

Correspondence Address: Law Office of William B. Ritchie, 43 Jackson Street, Concord, NH, 03301, US

(21) Appl. No.: 10/772,770

(22) Filed: Feb. 5, 2004

Related U.S. Application Data
(60) Provisional application No. 60/445,023, filed on Feb. 5, 2003.

(51) Int. Cl. H04M 3/42

(52) U.S. Cl. 379/201.02; 379/211.01

(57) ABSTRACT

A communication apparatus and method that enables a user to effect a change of telephone number, at will, without involving any technical support, or service provider personnel. Publishing a user's telephone number to a predefined list of third parties is also provided. Verification of the forwarded telephone number is provided as well as the ability of a user to invite or reject forwarded calls to accept or reject calls. Call management rules, affecting incoming calls, on a call by call, or calling party by calling party basis is provided on a case by case basis. These rules may further be applied to calling groups. The user may express the current user mode and indicate whether the user can be reached or not. Additional information related to calling parties utilizing a proprietary server or other third party directories, databases and the like can also be obtained. Further, authorized third party callers can communicate directly with the user's call management system. The user's handset may be locked, unlocked by the reception of a reception of a pre-defined short message transmitted via a corresponding server. The lock can be removed by entry of a valid PIN code on the keypad of the cellular phone. Further, the owner may place a permanent lock on the cellular phone, such that no calls can be made or received if the handset is stolen or lost. This lock can only be removed by the manufacturer of the cellular phone, or authorized agencies. Additionally, the owner may erase all memory contents of the cellular phone by reception of a pre-defined message.

### BACKGROUND OF INVENTION

This application claims benefit of U.S. Provisional Application Serial No. 60/445,023, filed Feb. 5, 2003, pursuant to 35 USC §119(e).

1. Field of the Invention

The present invention generally relates to a communication system, enabling a user to effectively prevent unsolicited contact from any uninvited third entity and a proof of possession method related to ownership of credit cards.

2. Description of the Related Art

To date telephony systems have presented their users with rigid frameworks, within which they have a basic set of features related to placing and managing calls.

Central to the many shortcomings of prior art is the fact that the user has a seemingly unrestricted public persona, in so far as the telephone number of the user can be readily transmitted simply by word of mouth, where the friends of the user can pass on the user's telephone number without first seeking permission. Obviously, this defeats the wish of those users who require having an unlisted number. Therefore, if the user feels their telephone number is known by too many unauthorized people then, apparently, the only course of action is to change to a new telephone number. However, with present systems, this incurs financial costs, time and administrative overheads, and the user must ask their service provider to execute the change of number for them, which invariably takes yet more time.

The related ability of having a user to inform a predefined group of third parties, of the user's telephone number change, or to have a user selectable number for each predefined group, is also not found in the prior art.

Virtually all kinds of telephony systems feature call forwarding, where the user does not wish to receive calls at the user's regular number, opting instead to have the calls redirected to another destination number. An annoying gap left in call forwarding systems is the lack of verification that the destination telephone number is valid, and that the receiver of the call at the destination is willing to accept forwarded calls.

Telephony systems also feature call barring, which typically prevents the user calling certain numbers, yet it allows any third party to call into the user. This is an inherent fault as it leaves the user open to a form of SPAM. SPAM is an annoying practice, where other users exploit electronic communications systems to deliver unsolicited messages, or other forms of information, to the users of the electronic communication systems.

Mobile telephones, in particular, pre-pay telephones, are widely available, and may be used to abuse legitimate network users, by bombarding them with SPAM. The anonymity, rightly afforded to any potential user, makes it difficult for users to know exactly who is calling, at least when contact is first established between two users. This anonymity leaves users open to abusive phone calls, the source of which can potentially never be traced. Prior art devices lack an ability to prevent a third party from calling the user, where the user will be able to authorize those third parties that are allowed to call in to the user, unassisted by any service provider personnel.

Present mobile cellular telephones are supplied with a hierarchical menu, which allows the user to both configure the handset, and customize the relationship between the handset and the cellular network. Handset is typically defined as any device which can be used to make and receive calls. For example, the GSM system will enable the user to have all calls forwarded to an Automated Call Handling System (ACHS) if the handset is out of signal range of the cellular network. The restriction this places on the user is inherent in the network itself, as oppose to the handset, in so far as all calls will be diverted to ACHS, not just those incoming from a specific third party. Current devices, especially cellular networks are designed to apply rules about call management in a global sense, i.e. they are applied to all calls, as oppose to allowing the user to apply call diversion to specific third parties or groups thereof.

Provisions for enabling the use of a user mode are not disclosed or suggested in the prior art. User mode is defined to mean the way in which a user of a telephony system changes between work, leisure or other such activities, throughout the course of a day. Examples of changing user modes are as follows. The user rises in the morning to begin the working day. Then, the user changes to lunch hour activities and returns to work, then perhaps visits a gymnasium. Finally, the user returns home. Each of the user modes would cause a user to wish to handle calls in a different manner. User modes and their related call handling methods would likely change from day to day, or at least from work days to weekend days. The capability of management of the user's calls to reflect the changes in the user's day is not found in the prior art.

Current systems restrict the amount of information a user has about incoming calls. When an incoming call is received by a handset, the user is informed of the calling telephone number. GSM handsets and the like then use this number to search the user's telephone directory, stored in the handset, to lookup the name of the third party who owns the number being provided to the handset by the cellular network. The “lookup” is often referred to as a reverse number lookup (RNL). Present devices lack the ability to use the RNL to find additional information, generally available on the internet and held in publicly accessible telephone directories. The additional information is not presently provided to the user via the handset as an incoming call is received.

Another deficiency in current devices is the inability for a third party to select to speak directly to ACHS. For example, if a third party wishes to tell a user of a telephone number, knowing that the user does not possess a means of noting down the number, the third party should be able to record a message, containing the telephone number, in the user's ACHS.

The prior art does not demonstrate a method of having a cellular telephone lock itself, upon receipt of a security message, transmitted by way of short message service (SMS). Many millions of cellular phones are lost or stolen annually, on a global scale. The cost to the consumer, arising from calls made from their lost cellular phones is often significant, and cellular network service providers offer little or no protection in such circumstances. Furthermore, the only means of locking a phone, known in the prior art, is to use a PIN CODE, which must either be entered before every call, or when the cellular phone is first switched on. This can be inconvenient for the user, particularly if large volumes of calls are being made. So no significant protection is found in the prior art for unlocked cellular telephones which are lost or stolen.

The prior art does not disclose a cellular phone that can erase its memory contents upon reception of an SMS message. Secondary to the inconvenience, of loss, or theft of a cellular phone, is the invasion of privacy which can occur due to the accessibility of personal information stored in the cellular phone or in the related SIM CARD. This can range from simple reading of telephone directories to reading personal and intimate information contained in stored SMS messages.

The prior art does not provide a cellular phone store that can provide a copy of any and all personal details on a central server, such that personal details are backed up, and can further be downloaded to any phone of choice by the user by a SMS.

Therefore, a telephony system and method that meets the call privacy and related security needs coupled with the use of secure electronic payment methods is not found in the prior art. A credit card system that operates in conjunction with a mobile phone is also not found in prior art devices.

### SUMMARY OF THE PRESENT INVENTION

It is an aspect of the present invention to provide a communication apparatus and method that enables a user to effect a change of telephone number, at will, without involving any technical support, or service provider personnel. The capability of publishing a user's telephone number to a predefined list of third parties is also provided. Verification of the telephone number to which incoming calls are to be forwarded or diverted is provided as well as the ability of a user to invite the receiver of forwarded calls to accept or reject calls, such that they can refuse unauthorized forwarded or diverted calls. A user can specify call management rules, affecting incoming calls, on a call by call, or calling party by calling party basis, which determines which callers are authorized to speak to the user. These rules may further be applied to calling groups. The user may express the user's current user mode, where user modes indicate the user's current personal situation and whether the user can be reached or not. Additional information related to calling parties utilizing a proprietary server or other third party directories, databases and the like can also be obtained. Further, third party callers can communicate directly with the user's ACHS, providing the third party has been authorized by the user to do so or the invention optionally transfer disconnected calls to the user's ACHS. In addition to the owner being able to lock the cellular phone, such that no calls can be made or received, the lock may also be activated by reception of a pre-defined SMS message. The lock can be removed by entry of a valid PIN code on the keypad of the cellular phone. Further, the owner may place a permanent lock on the cellular phone, such that no calls can be made or received. The permanent lock can be activated by reception of a pre-defined SMS message. In this case, the permanent lock can only be removed by the manufacturer of the cellular phone, or authorized agencies. Additionally, the owner may erase all memory contents of the cellular phone by reception of a pre-defined SMS message.

The invention enables the owner to store all personalized details, such as received SMS messages, telephone directories and the like, on a central server and to request all previously stored personal details be transmitted from a central server to the phone currently in the possession of the user.

A feature of the invention is to provide financial transaction verification features, such that the invention can verify for the third party that the user is physically in possession of a related credit card or other means of electronic payment and to assist in the management and authorization of financial transactions.

The invention provides facilities for interacting with third parties to effect call authorization and administration, such as approving calls received from third parties which are then handled by the user. The invention substantially enhances the control of the user's telephone number over that provided by current methods. A plurality of rules can be used to dictate any automated actions to be taken by the system when specified events are detected. The invention further incorporates financial transaction and related security capabilities. The invention is associated with a communication server which further enhances the variety of services provided to the user.

In the preferred embodiment, at least one telephone exchange, in the form of a computer server, and at least one handset is provided. To enable the user to easily learn to use the system, the “look and feel” of a typical mobile telephone is preferably utilized.

The invention gives the user a higher degree of control over accessibility by third parties through call management rules that allow the user to globally deny access to all calling third parties and choosing which third parties are authorized to call when each does so for the first time. Optionally, the invention could be configured to deny access to all calling third parties, placing the details of each in a buffer, which the user can browse at a later date, again, deciding which third parties to authorize.

Controlling accessibility is provided by the capability of permitting the user to change the user's telephone number at will, and without the intervention of any technical assistant or service provider.

The invention makes significant advances in call forwarding technology, by validating the destination for forwarded calls and optionally asking the destination if it wishes to receive the forwarded calls. The invention uses the notion of user mode to allow the user to express their current situation which will have a direct effect on how they handle calls throughout the day.

The invention makes further advances on CALLER ID displays by using reverse number lookup techniques, in order to enhance the amount of information available to the user about a third party when an incoming call is received.

The invention also allows callers to communicate directly with the user's ACHS even though the user may be available to talk, thus enabling callers to leave informational messages for the user, without the need to interrupt the user. The user will, in advance, authorize those third parties whom are able to utilize this aspect of the invention.

The present invention provides several SMS-centric technologies which are intended to further enhance protection of the user's privacy.

When loss or theft of a phone occurs, a greater inconvenience than simple loss of property is encountered. The owner of the phone looses control over the possession of their personal information, which is contained in various memory sections of the cellular phone, such as phone book and SMS message store.

In order for a user to protect their personal information, users must have some form of remote access control, in other words, a user must be able to remotely place a temporary lock, erase memory sections, or permanently lock their telephone. In the prior art, the only method of remote communication is via SMS messages. SMS messages have a very strong characteristic, in that they can be sent to a mobile phone which is actually switched off at the time of message transmission. The cellular network provider's systems will then ensure the SMS message is transmitted to the cellular phone the next time it is powered on. Therefore, when a user sends an SMS message to activate some security aspect of the present invention, to be activated, they are provided a high level of confidence that the message will arrive at the destination, thus, the security feature will be activated.

There are several instances of SMS-centric security features in the present invention.

In the first instance, the invention offers protection similar to that provided in the prior art, in that, the cellular phone can be remotely locked, then locally unlocked, by the normal unlock PIN code. Locally is defined as a user can interact with a cellular phone by pushing buttons on the keypad of the cellular phone. Remote is defined as the user can interact with the cellular phone by a SMS message.

The first instance allows the user to lock their phone anytime they believe they have forgotten to lock it by activating the lock locally, and is not necessarily done just because the cellular phone is lost or stolen. The first instance is referred to as a temporary lock.

In the second instance, the invention allows the user to lock the cellular phone remotely, in such a way that the keypad of the cellular phone is disabled. Effectively, any unauthorized person in possession of the cellular phone will not then be able to make any attempts to “crack” the unlock PIN code by making repeated attempts to enter the unlock PIN code locally. The second instance is referred to as a permanent lock.

Once a permanent lock has been placed on a cellular phone it is necessary to return it to the manufacturer, or an authorized agent. In the prior art, after the maximum number of incorrect PIN code entries has been exceeded, typically three times, then the phone must be unlocked by means of a PUK code (PERSONAL UNLOCK CODE) which is unique to every SIM chip. Once the PUK code is required by a cellular phone, only the unique code, which is many digits in length, will reactivate the cellular phone. This method is undesirable, therefore not available in the present invention when relating to temporary or permanent locks.

In the third instance a user can remotely request that the contents of their cellular phone are completely erased. This does not exclude use of other SMS-centric security features, which can be activated before or after temporary or permanent locks are placed on a cellular phone. The third instance is referred to as remote erase.

Remote erase affords the user the highest level of security, in that, even if the temporary or permanent lock features were defeated, the user's privacy is guaranteed.

The fourth instance is complementary to remote erase, in that remote erase would cause a total loss of personal information, therefore, the fourth instance allows the user to be able to store selected information on a central server, effectively providing a means of backup. The fourth instance is referred to as remote store.

Remote store allows the user to store telephone numbers and retained SMS messages on a corresponding database held on a server supported by the cellular network provider.

The fifth instance is further complimentary to remote store, in that it provides a corresponding means of retrieving information from remote store, having it downloaded to a cellular phone, currently in their possession. This allows a user to not only recover lost or stolen information, but it allows them to maintain several copies on alternate cellular phones, if so desired. The fifth instance is referred to as remote download.

An alternative to use of SMS communication is to utilize a WORLD WIDE WEB (WWW) based interface which allows user 100 to cause a service provider to automatically process each of the five instances above. In an embodiment which utilizes WWW in such a way, user 100 directs a WEB BROWSER, known in the art, to view one of five web pages, where each one of the five web pages relates to one of the five instances of SMS-centric features.

Each of the five web pages requires user 100 to identify them in a traditional manner, using a user name and password. This then allows user 100 to perform the same features as those triggered by SMS messages, provided the user's cellular phone is switched on.

Therefore, in an alternate embodiment, using WWW to trigger features of the invention, user 100 is able to remotely trigger security features, such as those described above, even if physical possession of the related cellular phone is not possible.

A further alternate embodiment is possible using public telephones, known in the art as PSTN. PSTN phones, such as public phones, home phones and other means of landline communication, can be used to contact the service provider and have each of the SMS-centric features triggered, either by use of an Automated Voice Response system, known in the art, or by having a live operator interact with user 100, to achieve the same goals as using WWW, as described above.

The invention further is able to interact with merchants to validate the use of payment cards such as CREDIT CARDS or EFTPOS CARDS, such that the merchant has a higher degree of confidence that the user is in possession of the cards.

Other aspects, features and advantages of the present invention will become obvious from the following detailed description that is given for the embodiments of the present invention while referring to the accompanying drawings.

### BRIEF DESCRIPTION OF THE DRAWINGS

FIG. 1 is a flow chart showing an overview of the invention and its corresponding components.

FIG. 2 illustrates the logic flow executed when a user wishes to change his/her telephone number.

FIG. 2a illustrates the logic flow executed when the user wishes the invention to provide an easy to remember telephone number.

FIG. 3 is diagram showing the sequence of steps to automatically inform the user's “close contacts” of major changes in the user's information.

FIG. 4 depicts the logic used for testing that a destination number, which is to receive forwarded calls, is indeed a valid telephone number.

FIG. 5 is a flow chart showing the steps involved to verify that a third party is willing to accept forwarded telephone calls.

FIG. 6 is block diagram showing the logic flow executed when an incoming call arrives at the invention.

FIG. 6a illustrates the selectable user modes.

FIG. 7 depicts the flow of logic for altering the current user mode.

FIG. 8 depicts the logic used to allow third parties to communicate directly with the user's ACHS.

FIG. 8a depicts the logic used to detect disconnected calls in order to forward third parties to ACHS in the event of loss of signal.

FIG. 8b depicts the logic of SMS-centric features.

FIG. 9 depicts an embodiment of a communication device having a cellular phone and credit card reader.

FIG. 10 illustrates the logic of remote authorization where a primary card holder has the ability to refuse transactions executed by other card holders.

### DETAILED DESCRIPTION OF THE INVENTION

The invention is an information processing apparatus and method having at least one handset, and at least one exchange, where the term “exchange” is defined to mean a related system that ensures calls can be made and received by the user, who is in possession of the at least one handset. The preferred embodiment is a cellular telephone network, and at least one handset, although the invention could also be envisaged as a landline telephony system or other similar multi-point/multi-user communication systems. Multi-point is defined as enabling a user to have several points of contact with the service provider, for example, multiple handsets.

The invention places the user in control of selecting which calls are permitted to reach either the ACHS or the user's handset. The features of the invention relate to ACHS, telephone number change under the control of the user and automated call authorization (ACA), and encompassing how the user operates call management.

Telephony systems, while fundamentally useful as a communication network, do not allow users a great deal of privacy, or control over key aspects over the setup of communication features. Current cellular networks provide handsets which appear to be laden with features. However, such devices are easily viewed as a basic feature expressed in many different ways yet there really isn't a great deal of varied functionality, just a few minor variations of simple services. For example, there are numerous ways to divert calls to ACHS if the handset is outside of range of the cellular network, or if the handset itself is simply switched off, but all such features are just the basic service of diverting calls to ACHS.

ACA enables the invention to decide, based upon rules expressed by the user, whether a third party is permitted to communicate with the user, or ACHS, or not at all.

Due to the fact that the invention enables the user to change their telephone at will, and for any reason, it would appear at first glance that a finite quantity of telephone numbers would be rapidly allocated. An inherent problem with reallocating numbers which were previously owned by other users is that s nuisance calls received by the original user would be targeted at the new owner of the number. In that only authorized callers may communicate with the user, nuisance callers are not on the call authorization list. Therefore, nuisance calls may only be received from authorized callers, who can easily be removed from the call authorization list. Thus, the original owner of the number should not receive too many nuisance calls and that the new owner of the number will receive zero nuisance calls, as the nuisance caller is not on the authorization list of the new owner of the number.

The invention enables the user to publish number changes to a predefined list of third parties. If the user does have to change his/her number, and then close third parties, for example employers or family members will be automatically notified of the number change.

The invention promotes the authorization of calls as much as possible to protect the privacy of those involved in making and receiving calls. This feature is highly valuable when considering forwarded calls. When a user instructs their telephony provider to divert calls coming to their handset, to a different location, it is entirely possible that an input error could occur. This could mean that the user forwards calls to an incorrect destination.

Nuisance calls can also be caused by incorrect or even intentional call forwarding setups. Cases have been noted where calls to businesses have been diverted to private telephone users, causing a large influx of diverted calls to arrive at the handset of the private user. Therefore, the invention provides a way of verifying the numbers to which calls are forwarded, and further, if the destination number is a user of the invention, invites the destination to authorize the forwarded calls. This saves time for the destination user, as one authorization will optionally allow all forwarded calls to come in, therefore the user will not have to authorize each incoming third party call.

A modern communication system, particularly a telephony system, is at first glance, a simple device that enables a user to make and receive calls. However, as the user begins to accrue a larger number of third party contacts they begin to feel the need for automatically handling calls. A basic form of automatically handling calls is a voice mail system. Typically, the voice mail system will receive calls when the user is unavailable, but the user can be unavailable for a number of reasons, and each reason may warrant a different behavior with respect to automatic call handling.

The invention enables the user to express his/her current user mode. Each user mode describes a period of time based on the twenty-four hour clock, plus optional specification of days of the week and/or calendar dates. User modes can be invoked on an ad hoc basis, meaning the user expresses to the invention that a specific mode has been entered. For example, a user mode, such as “at work” can be described as being a period of time between 9 am and 5 pm, where the user wishes for the invention to forward all incoming calls to the ACHS. A further user mode, such as “at home”, described as a period of time from 5 pm to 9 am, i.e. covering all the time when the user is not in the “at work” mode, can be used when the user wishes to manually handle all incoming calls. The “at work” or “at home” user modes can be invoked at will anytime the user wishes to have all calls handled in the related manner, regardless of whether or not the user is really at home or at work.

Invoking a user mode causes a related set of rules to come into operation. Set of rules is defined as a collection of instructions which dictates how the invention handles each individual incoming call. An example of a rule may be when the telephone number 1234567 calls the invention; the call is automatically forwarded to the ACHS. This example illustrates that all other calls, except those from the number 1234567 will be allowed to come straight to the handset where those from the number 1234567 will go to the ACHS and the user will later be notified of a new message being received.

Current systems allow handsets to hold a telephone directory containing names and telephone numbers of third parties with whom the user has become acquainted, referred to as directory entries. The prior art has also reached the point where directory entries can be grouped together under headings such as friends, or work contacts, such grouping being referred to as a call group.

The invention allows the user to apply a user mode to at least one directory entry or at least one call group.

The invention allows the user to specify that when new numbers are calling into the handset, i.e. they have not been authorized to call in, that the call be allowed the first time so the user can decide whether to accept future calls, or the call can be placed in an authorization buffer, where callers are browsed by the user and processed one by one.

When new numbers are encountered, the invention can use RNL to seek information from the internet to increase the quality of information provided to the user about a third party. This information is typically available from sources such as YELLOW PAGES, WHITE PAGES, ONLINE DIRECTORY ENQUIRIES and the like.

When a user is available to accept calls, the ACHS is disabled in present systems. Callers that wish only to leave an informational message for the user have no option but to speak to the user. The invention enables callers to opt to speak directly to the user's ACHS, for the purposes of leaving messages which the user may need to refer back to on a number of occasions. The user is in control of all such aspects, so only those callers who are authorized to speak directly to ACHS may do so. Furthermore, in any case, only those third parties who are authorized to leave messages on ACHS are allowed to do so, to prevent the user's ACHS from becoming flooded with SPAM.

Given the large number of mail order transactions which occur in the modern market place, fraudulent use of payment cards is constantly on the increase. However, studies show that fraudulent use occurs more frequently when physical possession of the payment card is not required. For example, when paying for gasoline at a service station, the customer is required to present a payment card, which is then swiped and verified by the related bank. However, internet purchases and purchases over the telephone require no proof of physical possession, i.e. the user does not need to be holding the card at the time of purchase. This lax method of collecting payment leads to an increase in fraud of an order of magnitude. Having a method of reading a payment card, coupled with a communication device, such as a telephone or mobile telephone, would enable a merchant to request that the user swipes the card, which must be in their possession, through the phone, which is equipped with a credit card reader. The telephone or mobile telephone would then electronically forward the details to the merchant, aiding in the alleviation of fraudulent payment card use.

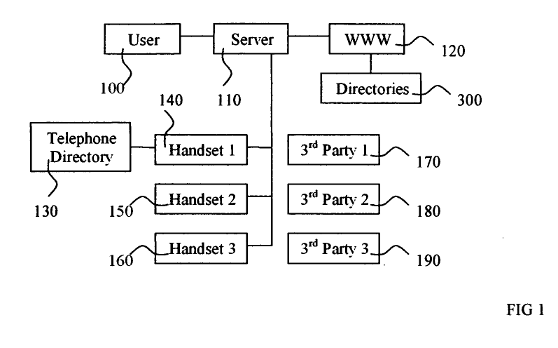

FIG. 1 is an illustrative overview of the invention with related handsets, communications equipment and third parties which will interact with the user during calls.

User 100 is in possession of handset 140, which can selected from but not restricted to a GSM MOBILE PHONE as manufactured by MOTOROLA or SAMSUNG. Handset 140 is used to communicate with server 110 which manages incoming and outgoing calls between user 100 and third parties such as third party 170, third party 180 and third party 190.

Handset 140 communicates with server 110 using a digital communication protocol provided for by the GSM STANDARD. The protocol allows for the transmission of voice or data, where data can be that which is normally provided for by a modem, as in packet data, or can be text messages sent and received by user 100, which are subsequently encoded/decoded for transmission and reception. The GSM STANDARD is adapted for carrying voice information. The emerging GPRS system could similarly be used as this also provides for an “always on” scenario where user 100 is always connected to WWW 120 and can simultaneously make and receive voice calls.

In order to provide additional information about calling third parties, server 110 will utilize the World Wide Web (WWW) 120; to enhance the amount of information user 100 has about any of the third parties when they call into the invention.

Current systems send only the telephone number of the calling party to handset 140 whereas server 110 enhances the information by providing information such as name, address, descriptions of services offered by the caller, all retrieved from services which are resident within WWW 120. Information provided by server 110 can also be stored in directory 130, a local telephone book contained in handset 140, which can be utilized by user 100 to place calls or to share information with other users of the invention. The enhanced information can be retrieved from directories 300 which include such services as YELLOW PAGES, WHITE PAGES and other databases providing information about individuals or businesses. Directories 300 can reside within WWW 120 or server 110.

With the GSM system, each of handset 140, and other handsets which include handset 150 and handset 160, further includes a SIM CARD, which has a globally unique identification (GUID) number contained within. Regardless of the telephone number assigned to each handset, the SIM card will always retain the same GUID throughout its life. Therefore, the user is able in present systems to lo request that their service provider change their number while retaining the same SIM CARD.

The invention improves upon this idea by allowing the user to request a number change simply by exchanging a sequence of messages with server 110. The sequence of messages, or any other sequence of messages between user 100 and server 110, can be enabled by using the SMS text messaging protocol, as is provided by the GSM standard. A “message” is defined as a single instance of a communication between user 100 and server 110.

FIG. 1 depicts three potential callers consisting of third party 170, third party 180 and third party 190. The potential callers are all unauthorized in the invention's initialized state. In the initialized state, no incoming calls will be answered by the invention until the user provides confirmation that calls will be received from the third party who is presently calling.

When one of potential caller's contacts user 100, by calling the user's designated telephone number, handset 140 informs user 100 of the incoming call, and tells user 100 that the caller is not authorized. The following diagrams describe the process of authorization or barring the incoming caller from making further calls to user 100.

Telephone directory 130, held in handset 140, or in an alternate embodiment, on server 110, contains the details of all callers who are authorized or barred. “Barred” means that user 100 will not be informed of any calls arriving from a third party whose authorization was previously refused. Instead, a log is kept which user 100 may view periodically, in order to see who is calling frequently. Constructing and maintaining log files is well known in the art.

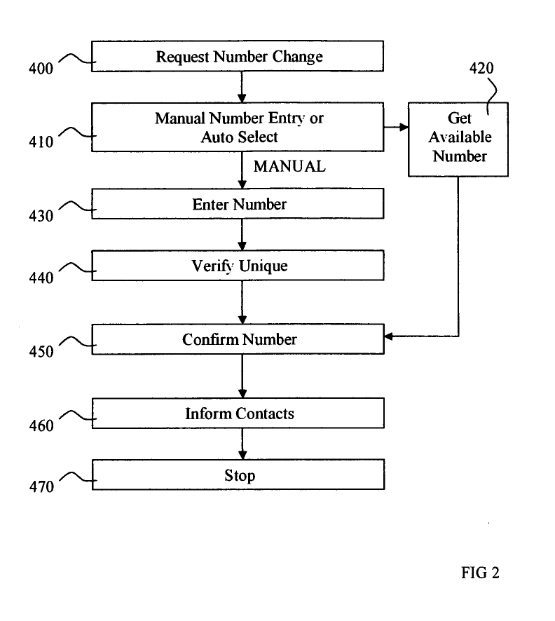

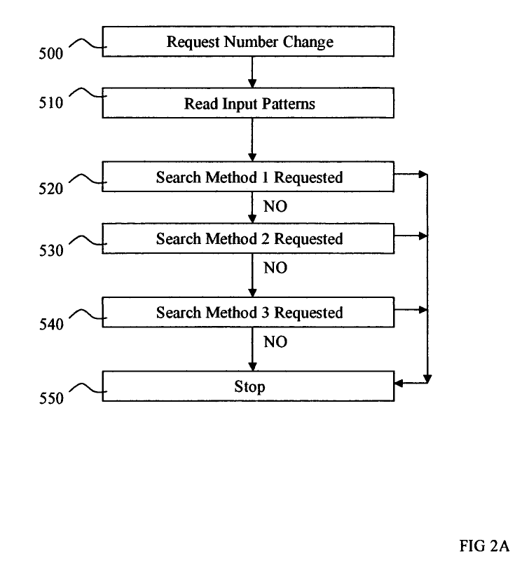

As shown in FIG. 2, the logic flow for changing the telephone number of user 100, solely under the control of user 100, is illustrated.

Beginning with step 400, user 100 sends a message to server 110 informing server 110 of the wish to have a new telephone number.

At step 410, the user can enter a telephone number of his/her choice or have server 110 assign the next available telephone number. The preferred method of the invention is that server 110 automatically selects the new telephone number, as this saves the user having to constantly re-key telephone numbers every time a number that is in use is selected. However, an alternative would be to use alphanumeric information as a “telephone number” which can ensure that most selected numbers would be unique. For example, a three letter code for the particular server, followed by a three letter code for the user, then a typical seven digit telephone number should eliminate most re-keying difficulties. Another alternative would be to have six letters of the user's name as the prefix which would probably be easier for third parties to remember. For example, RAMIAN 555-1234, RAMIAN 555-1235, RAMIAN 555-1236, etc. The number of telephone numbers corresponding to the user's SIM is limited only by the capacity of server 110 and the universe of unique “telephone numbers”.

If user 100 chooses to manually select their own new telephone number, then flow moves to step 420 where user 100 enters the new telephone number that they have thought of. At step 440 server 110 searches its internal directory of telephone numbers and ensures that the number entered by user 100 is unique.

If user 100 selects to have server 110 choose the next available telephone number then flow moves from step 410 to step 430, where server 110 reads the next available telephone number from its related database entry and temporarily allocates the number to user 100, until such times as user 100 accepts the change number which is decided at step 450.

At step 450, the user will confirm acceptance of the new number, and if the user is content with the new telephone number, flow moves to step 460 where the invention scans close contacts informing each number in the close contacts that the user now has a new number. If the user is not content with the new telephone number, then flow can restart at step 410 where the user can enter a new telephone number or once again request a number to be selected by server 110.

“Close contacts” is a list of third parties who user 100 considers worthy of automatically being informed of special events. The special events include such changes in state as user 100 changing the telephone number. When a special event occurs, server 110 will undertake to reduce the burden on user 100 by bulk messaging all third parties in the close contacts, such that each third party in the close contacts receives a message providing important information.

The database commands, necessary to enable the flow of logic depicted in FIG. 2 can be translated into SQL statements as supported by MICROSOFT SQL SERVER or ORACLE, both of which are scalable relational database systems, suitable for data storage and retrieval on a massive scale, as may be required for the invention when used simultaneously by a plurality of users 100.

Step 410 will require one SMS message to be sent by user 100 to server 110, detailing the request for the number change. For example, the text of the SMS message could be expressed in English like so, “CHANGE NUMBER TO 555 1234 5678”, server 110, when receiving this message, will then enact the request and change the telephone number of user 100 to that detailed in the message. Prior to enacting the change of number, server 110 will send a further SMS message to user 100, for example, “CONFIRM CHANGE OF NUMBER TO 555 1234 5678”. If user 100 does not reply to the message sent by server 110 within, say, ten minutes, then server 110 will abandon the change of number transaction and user 100 will receive a further SMS message, for example, “CHANGE OF NUMBER ABORTED”.

If user 100 were to send the change of number message formatted thus, “CHANGE NUMBER AUTO”, then this would inform server 110 that user 100 wishes the invention to automatically generate a new telephone number. The confirmation message would follow as previously detailed.

Referring to FIG. 2a which depicts the logic flow used to find an easy to remember telephone number as requested by user 100.

If the invention were to assign numbers in numerical order, for example beginning with the number 1111111 and assigning numbers sequentially, i.e. 11111112 followed by 1111113 etc, then users would find themselves being assigned telephone numbers which were not easy to remember.

It is not possible to ensure all users have an easy to remember telephone number, especially where telephone numbers are automatically assigned to users. However, many pattern algorithms which create repetition within a number are possible and a few are demonstrated in the preferred embodiment. By encouraging user interaction within the process of number generation, the invention finds an improved method of providing a telephone number which is desirable to the user.

The preferred embodiment demonstrates three search methods for automatic number generation. Each involves the creation of a number followed by a check to ensure the number is not already in use.

At step 500 the user requests a number change providing two pieces of input. The first is the ideal number, meaning the telephone number they most desire, and the second is the permitted alterations, meaning the ways in which the user will allow the invention to alter the ideal number if it is not available, in order to gain a unique telephone number.

The permitted changes input provides a template pattern which indicates static digits, where static digits can not be changed by the invention, and flexible digits, which may be altered by the invention, where a resultant telephone number is found to be in use. The template uses “#” characters to depict static digits and “*” digits to depict flexible digits. Therefore, if the user provides a permitted changes input of “##*##*” then the invention may only change the third and final digits of the number, digits 1, 2, 4 and 5 will remain as provided by the user.

The ideal number is identical in format to that provided at step 400 (See FIG. 2). For example the user could request the number 660660, and as this is the same three digit number repeated the user would find this easier to remember.

Search method 1 works where the user provides a permitted changes input of “##*##*” where the invention would try to use 660660, followed 661661, followed by 662662 etc, until a unique number was discovered or all permutations were exhausted.

Search method 2 requires the use of an additional character, “+”, depicting incremental groups of numbers. Incremental groups are a contiguous segment of a telephone number which are sequentially incremented together. For example, if the number 660111 was requested with a permitted changes input of “###+++”, then the invention would take the last three digits to be a number in its own right and increment it as such. Therefore the number 660111, followed by 660112, followed by 660113, potentially through to 660999, would all be tried as possible numbers.

Search method 3 is the more abstract and utilizes an alphabetic string to represent digits of the number. The permitted changes input changes radically in this instance.

If the permitted changes input contain alphabetical characters then the invention knows at step 510 that search method 3 is in force.

Each occurrence of an alphabetic character is substituted for a numerical digit, and each occurrence of the alphabetical character will be substituted with the same numerical digit.

For example, if a permitted changes input of “ABCABC” was provided then the first “A” could be substituted for any digit 0-9, and if in this example the digit was “4” then all occurrences of the character “A” would be substituted for the numerical digit “4”.

More exotic numbers can be created via this method which are not as easy to remember as previous search methods, but this method does potentially provide the user with greater control over the number being provided. Any numerical digits provided in the permitted changes input will be preserved in the output. This means that if the user provides a permitted changes input of “660AAB”, then the output number must begin with “660” followed by automatically generated numbers.

It is recognized that the time to create numbers and search a database to ensure each number is unique can be a time consuming process for a computer system. Therefore, the preferred embodiment offers a store of desirable numbers. The store of desirable numbers can be created by the system administrator, and it is likely that there will be multiple stores of desirable numbers. Each store of desirable numbers would represent possible matches against potential values for the permitted changes input.

In this instance the system administrator would utilize system idle time to create batches of desirable numbers, for use with permitted changes inputs similar to “##*##”. In this example the system administrator would be creating all permutations of numbers similar to “660660”, where “770770” and “880880” would all be stored in the store of desirable numbers related to the permitted changes input of “##*##*”.

As each number was allocated to a user the invention would remove it from the store of desirable numbers, ensuring it can not be issued again, and improving search speeds on future search method invocations.

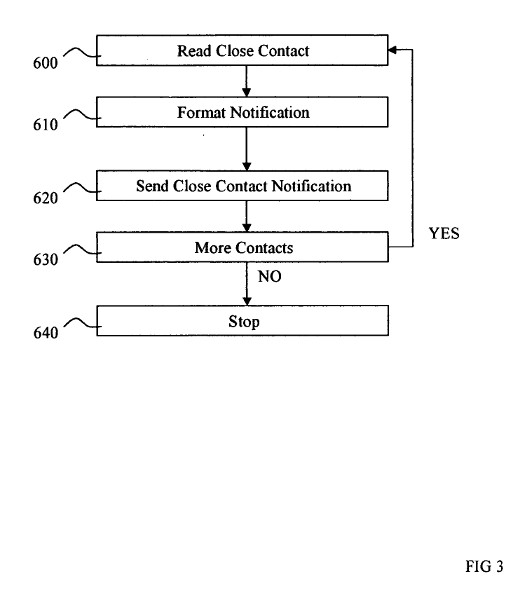

Referring to FIG. 3, the logic in step 430 is described in detail. User 100 is likely to invoke several major changes to their communication settings during their use of the invention. One such the major change is the change of telephone number. The close contacts are formed by user 100 to provide a list of third parties that user 100 wishes to be automatically informed whenever such the major changes occur. Having changed the telephone number, user 100 would have to find a way of informing important third parties of their new telephone number. If user 100 did not inform the important third parties of the new number, then they would all have to be authorized once again so that they could communicate with user 100. This represents a significant burden on user 100.

Therefore, user 100 can create a list of third parties, referred to as the close contacts; in the same way that user 100 can create a telephone directory in the handset. Close contacts for each user 100 are held on server 110, such that server 110 can conveniently access each close contact described by user 100 and automatically send an SMS message to each third party in the close contacts, informing them of important information regarding user 100.

Step 600 is the point where server 110 opens the list of the close contacts. If there are any entries in the list, then the first one is read upon the first execution of step 600. Subsequent executions of step 600 reached by flow returning from step 630 will read the next entry in the close contacts and so on until all close contacts have been sequentially processed.

At step 610, server 110 formulates an SMS message for transmission to each entry in the close contacts, which could be formatted thus, “USER RAMIAN HAS CHANGED NUMBERS TO 555 1234 5678”.

At step 620, the SMS message formatted at step 610 is transmitted in the same manner as the GSM protocol provided in present systems. At step 630, the next entry in the close contacts is read, if end of file is detected, i.e. there are no further entries in the close contacts, then flow ends at step 640, else flow returns to step 600 where the next entry in the close contacts is processed.

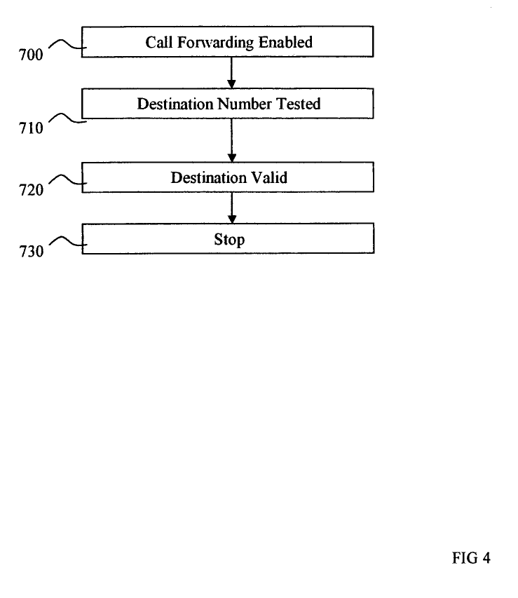

As shown in FIG. 4, the verification of the destination number for forwarded calls is provided. Each time a call forwarding action is requested by user 100, the invention will optionally verify that the destination number is valid. This can simply be enabled by dialing the destination number and if a ring or busy tone is detected, as oppose to a number unavailable tone, then the destination number is deemed to be valid. Other means of validating the destination number are recognized, such as utilizing a telephone directory, which may or may not contain the destination number.

At step 700, the user initiates call forwarding. Call forwarding includes, but is not restricted to, forwarding calls when user 100 is out of contact range of the GSM network, forwarding calls when user 100 has switched off the handset, forwarding calls of specific third parties who call user 100 and the like.

When call forwarding is initiated, then user 100 must provide a destination number to receive forwarded calls. This number is contacted at step 710. If the number is found to be valid then call forwarding is enabled and flow ends at step 730. If the destination number is found to be invalid then call forwarding is not enabled and flow returns to step 700 where user 100 can retry.

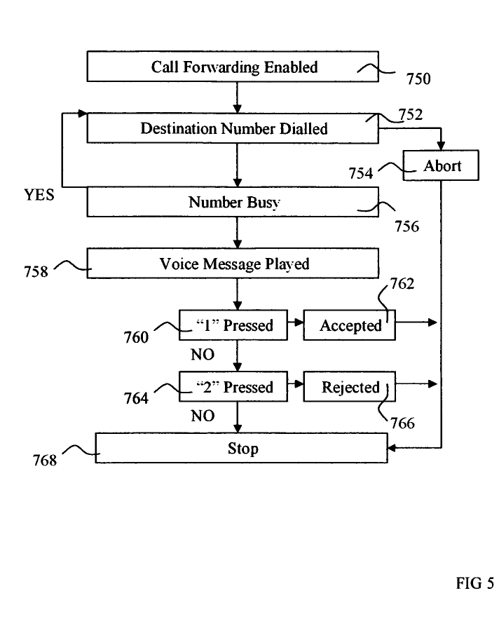

Referring to FIG. 5, the logic required to verify that the receiver of forwarded calls is willing to accept the forwarded calls is shown.

At step 750, user 100 initiates call forwarding providing a destination number. At step 752, server 110 dials the destination number. If a busy tone is detected at step 756, then server 110 will loop back to step 752 several times to retry the dial operation. If after several attempts, the number is still busy or is unavailable for some other reason, then the invention will move to step 754 where the call forwarding operation is aborted and flow ends at step 768.

If the destination number is answered by a third party, then a voice message, or other form of communication, is transmitted at step 758. The third party can indicate their acceptance of forwarded calls by playing a DTMF tone “1” at step 760 which causes flow to move to step 762, where user 100 is informed that the forwarded calls will be processed by the destination and flow ends at step 768. If the third party plays a DTMF tone “2” at step 764, then flow moves to step 766 where user 100 is informed that the third party will not accept forwarded calls. User 100 is then expected to find another way of handling forwarded calls, possibly by choosing a different destination.

The DTMF tone “1” and the DTMF tone “2” are used merely as an exemplary method of a third party responding to communication from server 110 under any circumstances. Automated voice response systems, known in the art, are common place and use DTMF tones to enable user 100 to navigate a set of menus which will route their call to an appropriate destination. Other means, such as voice recognition are possible and would fulfill steps 760 and 764 if the words “YES” or “NO” are spoken, for example.

The voice message can be recorded by user 100 in the same manner as user 100 can record a voice greeting to be used in conjunction with ACHS. The voice message can also be replaced by other means of communication such as SMS, where a message is formatted and sent to the destination, who can then reply by SMS indicating that they accept or reject forwarded calls from user 100.

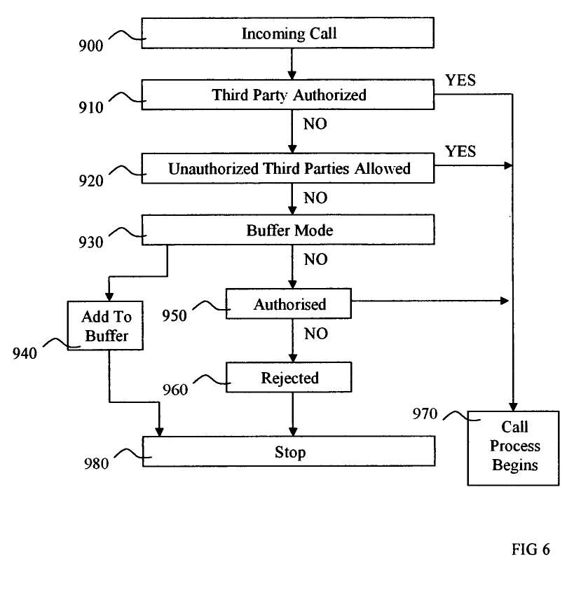

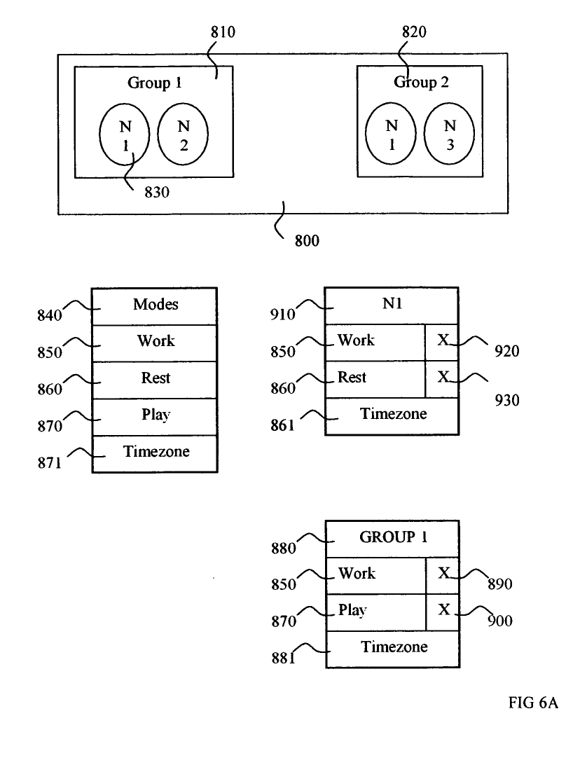

FIG. 6 illustrates the options that user 100 has for processing incoming calls. When the handset detects an incoming call, it must first search an internal authorization list. The internal authorization list is a collection of numbers of third parties who are authorized to communicate with user 100. The incoming call is not restricted to voice communication; it further includes, but is not restricted to, any form of communication such as SMS or data calls, therefore user 100 can prevent unsolicited SMS messages and the like, from having to be processed by user 100.

At step 900, The GSM network will, where possible, provide the handset with the CALLER ID of the third party who is attempting to contact user 100.

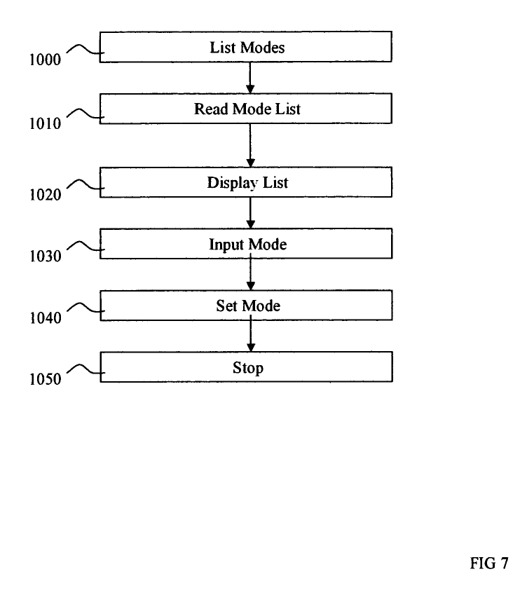

At step 910, the handset uses the CALLER ID as a database key to search the authorization list. If the CALLER ID is not found in the authorization list, then the third party attempting to contact user 100 is deemed to be an unauthorized third party (UTP). If the third party is found to be authorized, i.e. in the authorization list, then the call is processed at step 970. Step 970, which includes call processing logic as further described in FIG. 7.

If the third party is deemed to be an UTP, then flow moves to step 920 where user 100 may have all unauthorized calls allowed. This action would duplicate current devices, which allow all calls in to the handset, whether or not user 100 desires calls from certain third parties. If user 100 has allowed all UTP's to call, then flow moves to step 970 where the call is processed.

UTP's can be processed in one of two ways. First, they can be added to a buffer and second, they can be processed as the call occurs. At step 930, if buffer mode is in force, then all unauthorized calls are logged at step 940, where the details of the call are recorded for later inspection by user 100, flow finally ending at step 980. If buffer mode is not in force, then flow moves from step 930 to step 950, where the user is required to provide manual authorization for the incoming call, i.e. user 100 indicates that they are willing to accept the incoming call. If the incoming call is accepted flow once again moves to step 970. If the call is rejected, then, at step 960, the CALLED ID of the third party making the incoming call is added to a list of barred callers, making the third party a barred third party (BTP) and no further calls will be accepted from the BTP. All BTP's are held in a further log file which is searched when each incoming call is detected.

Returning to step 920, it is recognized that user 100 will optionally authorize all further calls from the incoming third party, or may choose to accept only the current call. If user 100 chooses to accept all future calls from the incoming third party, then the incoming third party is deemed to be an authorized third party (ATP), and as such is added to a further log containing CALLER ID's of all ATP's.

If a calling third party is neither an ATP nor BTP then the invention will require the user to manually authorize or reject the incoming call.

The logic depicted in FIG. 6 and later in FIG. 6a, as described in the preferred embodiment, will execute within the handset. Alternatively, if server 110 is constructed in such a way that it holds all telephone directories, and all aforementioned logs and lists for all users is similarly placed on server 110, then the logic depicted in FIG. 6 can be resident on server 110. This simplifies the construction of handsets for use in conjunction with the invention. It further simplifies the maintenance of the handset if changes to the logic described in FIGS. 6 and 6a, were ever to occur, in so far as only server 110 would require to be updated, as oppose to a vast plurality of handsets.

Referring to FIG. 6a, simple representations of a telephone directory, available user modes and available call authorizations are shown.

Block 800 represents the telephone directory held in the handset or on server 110. The directory holds contact details of third parties exemplified by N1 830. N1 830 is a single entry in directory 800. Block 810 and block 820 represent call groups. Call group 810 includes N1 830, N2 and N3. Call group 810 could be represented in life as some category such as friends, or workmates. Call group 820 is a further category of third parties. Both call group 810 and call group 820 are included within directory 800. This method of holding numbers and call groups is known in the art. However, the ability of each call group have its own “telephone number” to reach the user's phone is unique. The invention uses directory 800 as a way of identifying individual third parties who are authorized to call user 100.

Modes 840, which include work 850, rest 860 and play 870, are used to represent phases of the day entered into by user 100.

Work 850 is a mode entered into by user 100 during business hours. Rest 860 is a mode entered into by user 100 during resting hours. Play 870 is a mode entered into by user 100 when entering into any leisure activities.

All time zones, i.e. time zone 861, time zone 871 and time zone 881 are identical in so far they have at least a start time and end time. However, their impact on their related information differs slightly.

Time zone 861 and time zone 871 govern when incoming calls will be accepted from an ATP. For example, time zone 861 governs when N1 910 is allowed to call user 100. If time zone 861 is not completed by user 100 then the invention will allow N1 910 to call at any time, as long as N1 910 remains in the state of being an ATP. If user 100 provides details for time zone 861 then the invention will inspect the start and end times contained in the time zone and if the current time of day, at which the call is received, falls outside of the details contained within time zone 861, then the call will be rejected.

Time zone 881 behaves in an identical manner to time zone 861, except the impact of time control relates to authorization block 880, which governs when GROUP1 may call user 100.

Time zone 871 includes details of the time of day during which a given mode can become automatically activated by the invention. If Time zone 871 is not provided by user 100 for a given mode, then the mode must be manually invoked by user 100.

The invention will prevent user 100 from entering time zone details for time zone 871, which would effectively create an overlapping time period with a time zone for an existing mode.

Authorization 910 details under which conditions N1 830, being a potential calling third party, can contact user 100. Block 910 illustrates that N1 830 may call when user 100 is in the following modes, work 850 as indicator 920 shows and rest 860 which indicator 930 shows, and N1 910 may not call when user 100 is in any other mode.

Authorization block 880 illustrates that any third party in calling group 810, being named GROUP1, may contact user 100 when user 100 is in mode work 850 as shown by indicator 890 and play 870 as shown by indicator 900.

It can be seen that N1 830 has specific calling rules as depicted in block 910 which will override the generic rules depicted for calling group GROUP1 810, whose rules are illustrated in block 880, as N1 encompasses calling group 810. The invention provides that rules for specific third parties will override any generic rules which are imposed upon calling groups which may have the third parties as a member.

The preferred embodiment depicts user 100 maintaining lists of authorized and barred third parties via the handset, and more specifically the telephone keypad and display of the handset.

An alternative embodiment could be formed to use the WORLD WIDE WEB, via at least one web page which allowed user 100 to administrate their lists of authorized and barred third parties. Server 110 would then communicate any changes made to the authorized and barred third parties via SMS or other protocol such as WAP. This would liberate user 100 from the confines of a standard sized handset, making provision for the display of more call management information than can be presented on a standard handset. Should an alternate embodiment be formed where all lists of third parties are stored on server 100, as oppose to in a handset, then the web page extension to the preferred embodiment would be a highly efficient means of administrating the call management features of the invention. Web pages would be required for the addition and removal of third parties from both the authorized and barred third party lists. Furthermore the web page approach can be used for the creation and maintenance of mode information, governing when authorized third parties can call.

Referring to FIG. 7, the flow of logic for allowing user 100 to select and activate a specific mode is illustrated.

It will be recognized by one ordinarily skilled in the art that reading information from databases and displaying the information, such that a user may make a selection from options provided by the information, is a common task for any computer programmer and is well within ordinary skill of the programming art.

The sub routine for listing modes begins at step 1000.

At step 1010, all modes which the user has described to the invention are read.

At step 1020, the list of modes is displayed to user 100 and at step 1030 user 100 is required to make a selection from among the modes.

At step 1040, the invention implements the selected modes and all subsequent incoming calls will be handled according to the rules of the new s activated mode.

At step 1050, the flow of logic ends for implementing a selected mode.

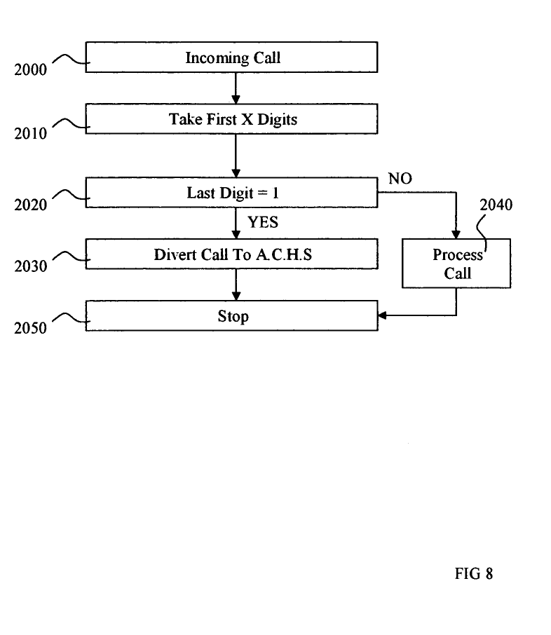

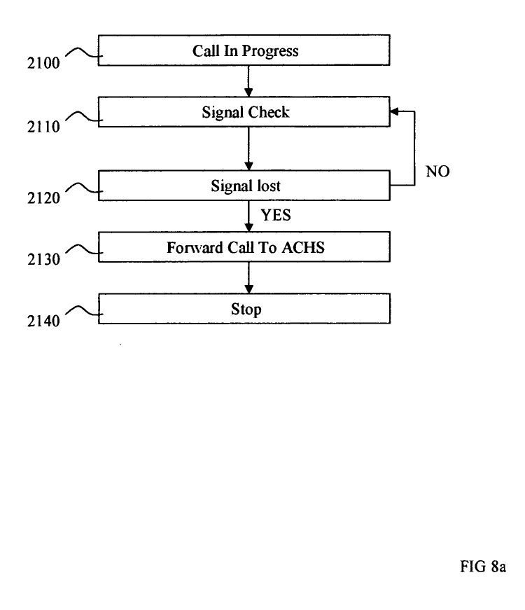

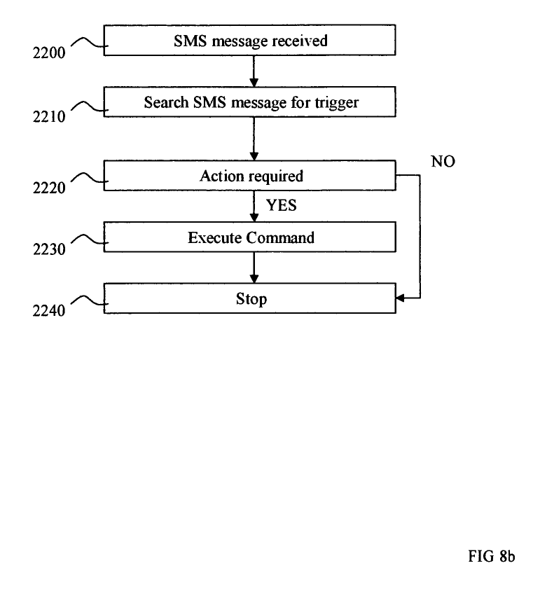

Referring to FIG. 8, the logic that allows third parties to contact the ACHS of user 100 directly is shown.

Telephone networks, known in the art, will typically allow network users to type any additional digits after a valid telephone number, and the additional digits will be discarded or passed onto to the recipient of the call. For example, if 555 12345678 were a valid number and a user dialed 555 123456789 then the additional digit in this case would be the digit 9. This digit can be passed along to the recipient of the call as the telephone network knows that only digits up to but not including the digit 9 are relevant.

The telephone network can be set to allow user 100 to dial a telephone number and place an additional digit on the end of the telephone number to indicate whether they wish to communicate only with the call recipient's ACHS. In this way, a caller may opt to leave a voice message or other form of message, without having to speak to the user. As noted above, longer “telephone numbers” are required; however, the use of mnemonics can greatly simply remember the additional alphanumeric information.

At step 2000, the subroutine for processing incoming calls begins.

At step 2010, the invention takes significant digits from the number dialed by the calling third party. The last digit, deemed not significant by the dialing process is then taken at step 2020, if the last digit is not a “1” then flow moves to 2040 where the call is processed.

At step 2030 a digit “1” has been detected and the caller is therefore diverted to ACHS as desired.

At step 2050 flow ends for processing direct calls to ACHS.

Returning to step 2040, where calls are processed, this executes the logic depicted in FIG. 6, in order that only ATP's can communicate with user 100.

FIG. 6a, which depicts information for user modes, can be enhanced by adding a field describing which callers, such as N1 830 (see FIG. 6a) may directly is contact user 100. In this way, user 100 can maintain a list of third parties who are allowed to contact ACHS directly.

Referring to FIG. 8a, which depicts the logic flow to detect loss of signal which can optionally cause third parties involved in disconnected calls to be forwarded to ACHS.

The subroutine begins at step 2100 where a call is in progress between user 100 and a third party.

A polling loop is formed at step 2110, which checks for a signal between the handset in use by user 100 and the cellular network of the service provider, and step 2120 which causes flow to move to step 2130 if the signal is lost. If the signal is still present then flow returns from step 2120 to step 2110. At step 2130, which is reached in the event of signal loss, the third party is diverted to ACHS in order that they can leave a message without incurring the time taken to redial user 100 simply to leave a message saying how they can be contacted when user 100 comes back into signal range.

Referring now to FIG. 8b, where detection of SMS-centric commands is shown.

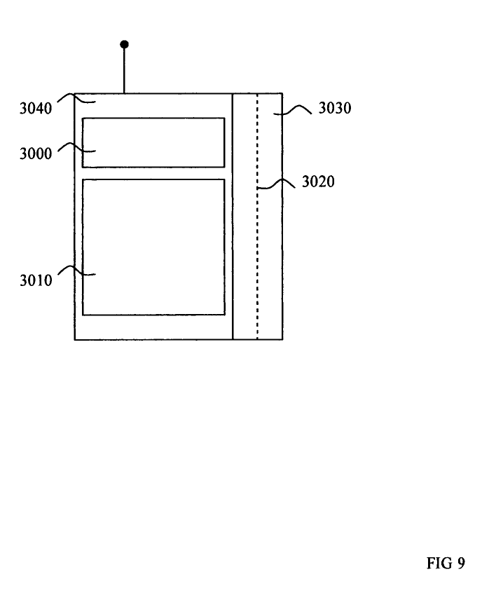

At step 2200 an SMS message is received by phone 3040 (later depicted in FIG. 9). SMS messages are known in the art as a means of transmitting text to and from cellular telephones.

The present invention utilizes this technology to send and receive commands which activate disclosed security and privacy features. The security and privacy features are an extensible set of commands, which are executed upon reception of an SMS message having a trigger string. An individual trigger string is required to be unique to each individual member of the extensible set of commands (ESC).

Trigger string is defined as a portion of an SMS message which corresponds exactly with a predefined string related to only one member of the set of extensible commands.

The ESC includes at least the previously disclosed temporary lock, permanent lock, remote erase, remote store and remote download.

To enable the ESC, at step 2210, each received SMS message is searched for the trigger string. Each received SMS message may or may not contain a trigger string, as reception of an SMS message containing the trigger string would not be the norm.

In order for execution of a specific command provided by the ESC, the related trigger string to at least one member of the ESC must occur in an SMS message. Therefore, step 2210 is required to provide a search method, known in the art, in order to find strings within strings, commonly referred to as an “in string” search, or to quote the BASIC LANGUAGE keyword, INSTR.

Upon reception of an SMS message, the INSTR search is executed using each trigger string relating to each member of the ESC. Therefore, there is a corresponding set of numerous trigger string (STS) the members of which relate on a one to one basis with the ESC.

For demonstration purposes, the STS includes “!TEMPLOCK!”, to cause execution of the temporary lock, “!PERMLOCK!”, to cause execution of the permanent lock command, “!REMERASE!”, to cause execution of the remote erase command, “!REMSTORE!”, to cause execution of the remote store command, “!REMDOWNLOAD!”, to cause execution of the remote download command.

It can be seen that the trigger strings of STS are highly unlikely to occur in any normal SMS message. However, each trigger string has a suffixed password known only to user 100.

The suffixed password appears on the trigger string for the remote erase command, thus, “!REMERASE!PASSWORD”. The text “PASSWORD” is replaced by the actual password desired by user 100. This method prevents other people sending SMS messages to a cellular phone in order to cause unauthorized execution of commands.

Step 2220 includes the INSTR search method, whereupon, if no INSTR searches return a TRUE condition, indicating that a trigger string was found in a received SMS message, then execution ends at step 2240.

At step 2230, which is reached if the INSTR search returns a TRUE condition, the related member of ESC is executed.

In order to enable each member of ESC, the following steps are necessary. For the temporary lock, the cellular phone should be locked, pending entry of an unlock PIN code, as though the phone had been locked locally by executing a menu selection, known in the art. This is contained within the software of the cellular phone.

For the permanent lock, the cellular phone should be locked as though the phone had been locked locally, but further, the keypad should be disabled, preventing any local unlock attempts. The cellular phone, once in the permanent lock condition, is required to be unlocked by a hardware connection, known in the current art to manufacturers and authorized agents.

For the remote erase, the cellular phone should delete at least, all telephone directory entries, all retained SMS message and all lists of made and received calls.

For the remote store, the cellular phone, may by transmitting individual SMS messages, send individual records from the telephone book, list of retained SMS messages, lists of made or received calls, to a central server, which will retain the individual records on a database, such that user 100 can request them to be downloaded from the database at a future time.

For the remote download, user 100 is required to transmit at least one SMS message to recover records from the database. User 100 may request that all stored records are recovered from the database, by sending an SMS message, exemplified by the text, “!SENDALL!”, to the server. The server knows which cellular phone the SMS message was transmitted from and will proceed to send the required details back to same cellular phone. Again, the suffixed password will be provided in the exemplified text. Therefore, user 100 can reload information into a cellular phone from which it was previously uploaded.

In order to have information received into a cellular phone, other than that from where it came, then an exemplified command, such as, “!TRANSFER!NUMA! PASSWORD!”, is required, where the “!TRANSFER!” portion informs the server, that user 100 wishes to have a copy of his/her information sent to a different cellular phone, “!NUMA!”is the number from which the information was originally uploaded, and “!PASSWORD!”is the keyword known only to user 100, used to authorize the transfer of his/her personal information to another cellular phone.

Other commands can be added to the ESC, using the disclosed method and are determined by the natural set of commands which relate to everyday database operations, and can relate to the transfer of ring tones, visual images such as icons, captured images and the like. Further, commands include cloning the entire set of one user's personal information such that all personal details are sent to the cellular phone of another user. This feature is useful for sales representatives, whose managers would want to upload a list of customers which need to be contacted.

Referring to FIG. 9, the embodiment of phone 3040, having card technology is shown. The mobile communication equipment is satisfied by the inclusion of handset 3040 which includes display 3000 and keypad 3010.

FIG. 9 further depicts card reader 3030, which includes slot 3020 through which is passed a credit card, or similar payment card, or any other card having a magnetic strip.

Whenever user 100 contacts a merchant and wishes to pay by credit card, the merchant may require user 100 to prove physical possession of the credit card. User 100 will, in this instance, swipe the credit card through slot 3020, enabling card reader 3030 to read the information from the credit card.

Card reader 3030 will then pass the details, read from the credit card, to phone 3040, in order that the details can be transmitted to the merchant, by utilizing the serial communication interface contained within handset 3040. In this embodiment, the invention would temporarily be used as a modem for transmitting the credit card details.

The merchant will then have a higher level of certainty that user 100 is in possession of the credit card at the time the transaction is executed.

Some credit cards have various forms and nuances. For example, EFTPOS CARDS in some countries require a PIN NUMBER to be entered by user 100, after the EFTPOS CARDS have been swiped. In this case, display 3000 can be utilized to prompt user 100 and keypad 3010 can be utilized by user 100 to provide the PIN NUMBER.

SMART CHIP READERS can be substituted for card reader 3030, depicted as a MAGNETIC CARD SWIPE. Also, PROXIMITY READERS can be substituted for card reader 3030. Then, the credit card, if so enabled, would merely have to be brought into close proximity of reader 3030, as oppose to user 100 having to insert the credit card into the device depicted in FIG. 9. Phone 3040 can be optionally equipped with forms of wireless communication such as, BLUETOOTH and the like, which enable phone 3040 to communicate with card readers without the need for a cable connection to the card readers. Infra-red communication, referred to as IRDA and the like, can also be used to enable two way communication between phone 3040 and card reader 3030.

The invention also facilitates rules that can be contained within the Preferred Communication Device (PCD) used by the primary card holder. One such device is phone 3040, which can be used by the primary card holder to automatically govern the spending capabilities of all card holders.

Transaction limit is defined as the maximum amount of money that can be spent on a single transaction by a card holder. The transaction limit can be set individually for each card, secondary or primary, by the primary card holder.

The PCD has basic computing capabilities, as is the case for any mobile telephone supporting WAP or GPRS capabilities, or most mobile phones known in the art. Similarly, PDA's and other pocket computing devices, coupled with a form of communication will also act as a PCD.

When the primary card holder is queried by the credit card company for their authorization of any transaction, the PCD can be set by the primary card holder to automatically provide an authorization response. The card in use must have sufficient credit limit, allocated from the total credit limit of the primary card holder. If the transaction would exceed the credit limit, allocated by the primary card holder, then the PCD automatically responds with a declined response.

The PCD will also examine the transaction limit allocated to each card, such that if the amount of the transaction exceeds the related transaction limit then authorization will be declined by the PCD.

The role of the PCD is to lighten the load on the primary card holder in automatically processing authorizations. The primary card holder is free at any time to say whether the PCD should act in this role or not. The primary card holder may only wish for the PCD to act in this role if they are not available in person to process transactions.

The invention functions to provide that proof of possession of a credit card is being sought. Also, the invention serves to provide a response from a pre-agreed telephone number, used by the primary card holder.

Therefore, theft of a credit card, using the invention is sufficient to defraud the credit card company. An unauthorized transaction would also require use of the PCD, which is unlikely to be available to any unauthorized user. Additionally, the PIN CODE used by the primary card holder to authorize transactions must be known, making it increasingly unlikely that unauthorized users will be successful in defrauding credit card companies.

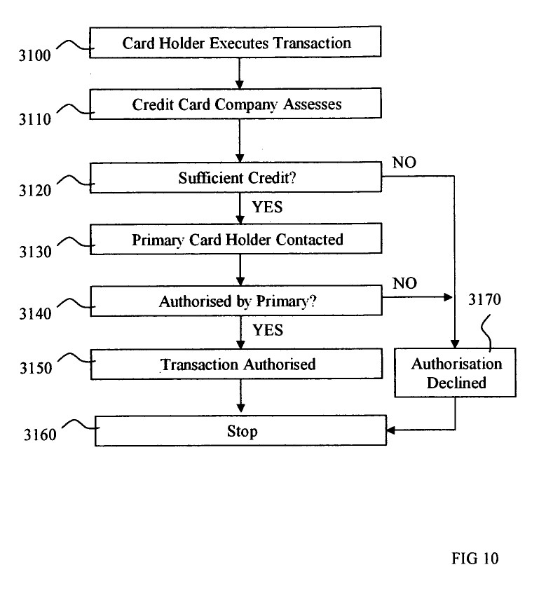

Referring now to FIG. 10, the flow of activities required to implement a more secure method of authorizing credit card transactions is shown.

Credit card companies issue a credit card, in the first instance, to an individual referred as the primary card holder. The primary card holder is typically the individual who is legally responsible for payments and the safety and security of the credit card. At the time of issuing, the credit card to the primary card holder, or at any future time, the credit card company, will at the request of the primary card holder, issue cards to other named individuals. The individuals are known as secondary card holders. The secondary card holders are authorized to execute transactions which will be reflected on the bill issued to the primary card holder. It can be seen that, as there are more cards issued, effectively in the name of the primary card holder, that the financial risk, due to loss of any card, theft of any card, or any other fraudulent use, is significantly increased.

Therefore, the invention incorporates a method of increasing security, which involves the credit card company seeking the authorization of the primary card holder for transactions executed by any primary or secondary card holders.

The invention also promotes the allocation of a credit limit to each secondary card holder, which represents a portion of the credit available to the primary card holder. For example, if the primary card holder has a credit limit of $10,000 and there are four secondary card holders, then each secondary card holder could be restricted to a maximum balance of $1,000. This means that the primary card holder's limit would be set at $6,000, if all card holders use their maximum allowance limit since the $10,000 would be reached. At all times, the primary card holder is in control over the portion of the credit limit allocated to each secondary card holder, and can increase or decrease it accordingly. Similarly, the primary card holder can temporarily suspend use of any secondary card.

At step 3100, a card holder, either primary or secondary, executes a transaction. The merchant will read the credit card details which will in turn be passed to the credit card company. At step 3110, the credit card company will see if the primary card holder has sufficient remaining credit to support the transaction. If not, the transaction will automatically be declined by the credit card company shown by flow moving to step 3170.

At step 3130, the primary card holder is contacted for additional authorization which can be provided by the primary card holder entering a pin number on a telephone, using DTMF, or by voice communication. However, the invention promotes the use of phone 3040 (see FIG. 9) at step 3130 by sending a message to the phone of the primary card holder. The primary card holder then replies to the message indicating whether the transaction is authorized at step 3150 or declined when flow moves to step 3170. In either instance flow ends at step 3160.

The illustrated embodiments of the invention are intended to be illustrative only, recognizing that persons having ordinary skill in the art may construct different forms of the invention that fully fall within the scope of the subject matter appearing in the following claims.

What is claimed is:

1. An automated call handling system comprising:
at least one handset adapted to receive and transmit telephony communication;
at least one computer server, associated with said at least one handset, wherein said at least one computer server functions as a telephone exchange regarding said at least one handset; said computer server having an account number and a plurality of handset numbers corresponding to said account number wherein said handset number used to contact said handset can be changed at will by a user in response to a telephone call made to said automated call handling system's (ACHS's) account number.

2. The automated call handling system of claim 1 wherein said computer server has a mode having an authorization code corresponding to the time of day, day of week, and calling party such that the user can change authorization code at will.

3. The automated call handling system of claim 2 where the authorization code can be used to direct the telephone call to ACHS to a particular said at least one handset in accordance with mode setting provided by the user.

4. The ACHS of claim 3 further comprising means for providing additional information to the user about the identify of the telephone call made to the ACHS such said the user can decide whether to accept or reject the telephone call.

5. The ACHS of claim 4 further comprising means for sending a coded message to said at least one handset in response to a security message received by said ACHS which results in said at least one handset being totally blocked as to incoming and outgoing calls if said at least one handset is lost or stolen.

6. The ACHS of claim 5 wherein said security message can be unlocked by a personal identification number.

7. The ACHS of claim 6 wherein said security message can only be unlocked by the phone manufacturing or the phone manufacturer authorized representative.

8. The ACHS of claim 7 further comprising means for downloading the information stored on said at least one handset to said computer server.

9. The ACHS of claim 8 wherein said computer server further comprises means for transmitting downloaded information receiving from said at least one handset to another handset in response to a telecommunication request by the user.

10. The ACHS of claim 1 wherein said computer server further comprises means for communicating the use's telephone on said at least one handset to a pre-determined list of third parties.

11. The ACHS of claim 10 wherein said computer server further comprises means for accepting refusal for receiving call forwarding calls from the user's said at least one handset.
